(19) United States
(12) Patent Application Publication
(10) Pub. No.: US 2024/0361459 A1
(43) Pub. Date: Oct. 31, 2024

(54) EVENT CAMERA WIDE AREA LASER DETECTION AND RANGING

(71) Applicant: Arete Associates, Northridge, CA (US)

(72) Inventor: Paul Bryan Lundquist, Longmont, CO (US)

(73) Assignee: Arete Associates, Northridge, CA (US)

(21) Appl. No.: 18/647,720

(22) Filed: Apr. 26, 2024

Related U.S. Application Data
(60) Provisional application No. 63/462,322, filed on Apr. 27, 2023.

(51) Int. Cl. G01S 17/42; G01S 7/481; G01S 7/4911; G01S 7/493; G01S 17/894

(52) U.S. Cl. CPC G01S 17/42; G01S 7/4817; G01S 7/4911; G01S 7/493; G01S 17/894

(57) ABSTRACT

A Lidar system herein includes a transmitter operable to rotate at a first rate, and to transmit laser light along a first path from the Lidar system to a target, and a receiver operable to rotate with the transmitter, and to receive at least a portion of the laser light along a second different path from the target. The system includes an event-camera having a plurality of pixels being triggerable by photon flux changes. A processor calculates a range and an angle to the target using an angular displacement between the second path and the receiver that arises from the first rate of rotation for the transmitter and the receiver and, in part, from event data of at least one of the pixels based on a direction of the first path at a time of a photon flux change and a pixel coordinate of the at least one pixel.

### CROSS REFERENCE TO RELATED APPLICATIONS

This patent application claims priority to, and thus the benefit of an earlier filing date from, U.S. Provisional Patent Application No. 63/462,322 (filed Apr. 27, 2023), the contents of which are hereby incorporated by reference. This patent application is also related to commonly owned U.S. Pat. No. 11,506,786 (issued Nov. 22, 2022), the contents of which are incorporated by reference.

### BACKGROUND

Light Detection and Ranging, or “Lidar” (also referred to as Laser Detection and Ranging, or “LADAR”) generally involves propagating a pulse of laser light to an object and measuring the time it takes for the pulse to scatter and return from the object. Since, light moves at a constant and known speed (i.e., ˜3×10⁸ meters per second in air), the Lidar system can calculate the distance between itself and the target. However, these pulsed Lidar systems can produce range ambiguities for a variety of reasons. For example, if all pulses are essentially the same, the Lidar system may not know which pulse is being received at any given time. Thus, the Lidar system may not know the correct time it took for a pulse to return from a target. And a Lidar that rapidly scans a volume with a series of pulses for contiguous coverage of a volume without gaps generally only scans at an angular rate commensurate with a pulse repetition frequency, which is limited by range ambiguity.

Commonly owned U.S. Pat. No. 11,506,786 remedied these design constraints with a new type of rapid scanning Lidar, in which a laser beam is rapidly scanned and scattered from either hard surfaces or volumetric scatterers at some distance away. The scattered light is received by the Lidar at an angle lagging the scanner direction that is in proportion to the range and the rotation rate of the scanner. The scattered light is imaged onto an array of detectors where the location, or coordinate, of the detector within the array is related to the position of the scatterer. When a conventional framing camera is used for the array of detectors, exposure times for pixel detectors outside of the time window where received laser signal can be obtained is a source of noise, limiting detection capability.

U.S. Pat. No. 11,506,786 offered multiple remedies to limit pixel exposure based on laser scanning position, or by mechanically rotating an image so that the pixels are continuously aligned to receive light scattered from the laser beam. For example, the embodiments of U.S. Pat. No. 11,506,786 provide a very rapid contiguous scan from a continuous wave laser through a rotated azimuthal path about a rotation axis. And, a second slower scan is used to obtain scanning in a second angular direction. The resolvable range is proportional to the laser beam divergence, and the use of a low-divergence laser beam limits the speed at which the second slower scan can be completed (e.g., within continuous coverage).

### SUMMARY

Lidar systems and methods presented herein employ rotating transmitter and receiver elements. The embodiments herein provide improvements over U.S. Pat. No. 11,506,786 through an imaging detection technique capable of reducing the impact of solar background, while at the same time simplifying the system architecture, reducing cost, and reducing the required size, weight, and volume (e.g., SWaP). The embodiments herein also increase the second “slow” scan rate of the sensor without substantial sacrifice of the range or angular resolution. And an image architecture more suitable for direct identification of target pixel coordinates and mapping to target physical coordinates is employed.

The embodiments herein advantageously enable Lidar detection of small, isolated targets such as small unmanned aerial systems within a monitored air space. This has the advantage of enabling detection without radar, during day or night, and with reduced influence of background image clutter. The embodiments herein are also suitable for airspace monitoring from moving platforms.

In one embodiment, a Laser Ranging and Detection (Lidar) system includes a laser operable to generate laser light, a transmitter operable to rotate at a first rate, and to transmit the laser light along a first path from the Lidar system to a target, and a receiver operable to rotate with the transmitter, and to receive at least a portion of the laser light along a second path from the target. The first and second paths are different. The system also includes an event-camera having a plurality of pixels, each pixel being triggerable by photon flux changes. The system also includes a processor operable to calculate a range and an angle to the target using an angular displacement between the second path and the receiver that arises from the first rate of rotation for the transmitter and the receiver and, in part, from event data of at least one of the pixels based on a direction of the first path at a time of a photon flux change and a pixel coordinate of the at least one pixel.

The processor may be further operable to select the event data by excluding pixels of the event-camera that have not been triggered from the laser light along the second path from the target. The processor may be further operable to calculate the range and the angle to the target by derotating pixel event coordinates of a laser scan angle at a time of the event data, and by comparing the derotated pixel coordinates to a previously calculated pixel range map. The processor may be further operable to calculate the range and the angle to the target by derotating pixel event coordinates of a laser scan angle at a time of the event data, and by comparing the derotated pixel coordinates to a previously calculated pixel elevation correction map.

The receiver and the transmitter both rotate about axes aligned in a same direction (e.g., attached by a common rotating shaft). The receiver and the transmitter each comprise a monogon shaped mirror. For example, the mirrors of the receiver and the transmitter are configured at angles that are complementary to one another. At least one of the receiver and the transmitter comprises a transmissive scanner driven by a perimeter driven motor. For example, the transmissive scanner may be a rotating diffractive scanner, or a rotating refractive scanner. The receiver and the transmitter are operable to conically scan. For example, the Lidar system 10 may comprise an axle configured to rotate the receiver and the transmitter to conically scan via a precession rotational axis.

In some embodiments, the transmitted laser light is tuned on and off of an absorption line of a volumetric target. And, in some embodiments, the Lidar system may include a detector configured to detect a wavelength of received laser light that differs from a wavelength of the transmitted laser light due to distributed scatterers. And, in some embodiments, the laser light comprises continuous wave laser light.

In another embodiment, a Lidar method includes transmitting laser light from a transmitter rotating at a first rate along a first path to a target, and receiving at least a portion of the laser light along a second path from the target with a receiver rotating with the transmitter. The first and second paths are different. The method may also include triggering at least one pixel, of an event-camera having a plurality of pixels, with a photon flux change, and calculating a range and an angle to the target using an angular displacement between the second path and the receiver that arises from the first rate of rotation for the transmitter and the receiver and, in part, from event data of at least one of the pixels based on a direction of the first path at a time of a photon flux change and a pixel coordinate of the at least one pixel.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIGS. 1A and 1B are block diagrams of an exemplary Lidar system.

FIG. 2 is a flowchart of an exemplary process of the Lidar system of FIG. 1.

FIG. 3 illustrates how a high-speed scanner of the embodiments herein can detect the position of targets within a plane, in one exemplary embodiment.

FIG. 4 provides a simplified view of a scanner, in one exemplary embodiment.

FIG. 5 shows the scaled and rotated image pattern of target images in an image plane overlaid on top of actual positions of the target locations, in one exemplary embodiment.

FIG. 6 shows a scanner comprising a motor/balancing module configured with a transmit mirror and a receiver mirror at complementary angles, in one exemplary embodiment.

FIG. 7 is a graph illustrating an array of targets with increasing ranges, in one exemplary embodiment.

FIG. 8 is a graph indicating an angle to a target in increments of 30 degrees, and elliptical lines corresponding to successive ranges in 500 m increments, in one exemplary embodiment.

FIG. 9 shows a mapping of pixels to cartesian coordinates of a detected target where units associated with position are in 500 m increments in both the horizontal and vertical coordinates, in one exemplary embodiment.

FIGS. 10 and 11 shows curves which correspond to regions of the image plane that may be illuminated by target angles as the scanner moves through 30 degree scanning increments, in one exemplary embodiment.

FIG. 12 shows a pattern formed by scanning laser light at a 75-degree precessing angle to a fast scan axis, while the fast scan axis maintains an angle of 15 degrees with the vertical axis, in one exemplary embodiment.

FIG. 13 is a graph that shows power per solid angle as a function of the angle from zenith, in one exemplary embodiment.

FIG. 14 is a pixel intensity vs. time graph illustrating one exemplary optical signal that a single pixel on a 2D image plane of the event camera would observe during two full 360-degree laser scans with a single target in view.

FIGS. 15A and 15B show exemplary event pixel positions at two times during a 360-degree scan.

FIG. 16 is a block diagram of a system for processing event camera data from an event camera to produce target tracks, in one exemplary embodiment.

FIG. 17 is block diagram of a monogon imparting a divergence along the polar angular direction, in one exemplary embodiment.

FIG. 18 is block diagram of an elliptical laser beam illuminating two targets at two elevations, in one exemplary embodiment.

FIG. 19 illustrates elevation detection with an event camera image plane, in one exemplary embodiment.

FIGS. 20A and 20B illustrate event camera wide area detection of an earthen berm before filtering (FIG. 20A) and after filtering (FIG. 20B), in one exemplary embodiment.

FIG. 21 is a block diagram of an exemplary computing system in which a computer readable medium provides instructions for performing methods herein.

### DETAILED DESCRIPTION OF THE FIGURES

The figures and the following description illustrate specific exemplary embodiments. It will thus be appreciated that those skilled in the art will be able to devise various arrangements that, although not explicitly described or shown herein, embody certain principles and are included within the scope of the embodiments. Furthermore, any examples described herein are intended to aid in understanding the embodiments and are to be construed as being without limitation to such specifically recited examples and conditions. As a result, the embodiments are not limited to any of the examples described below.

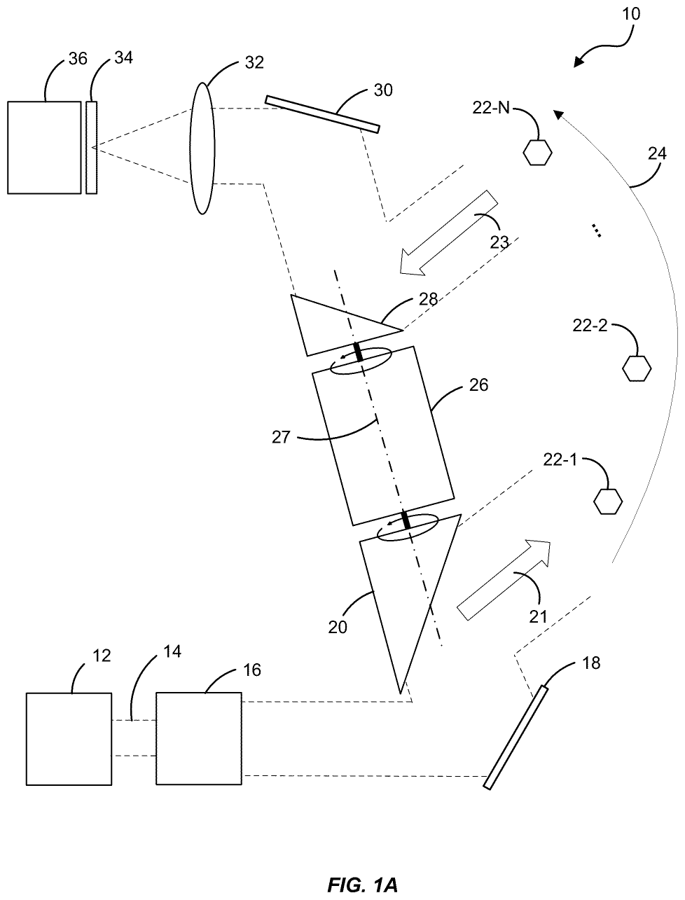

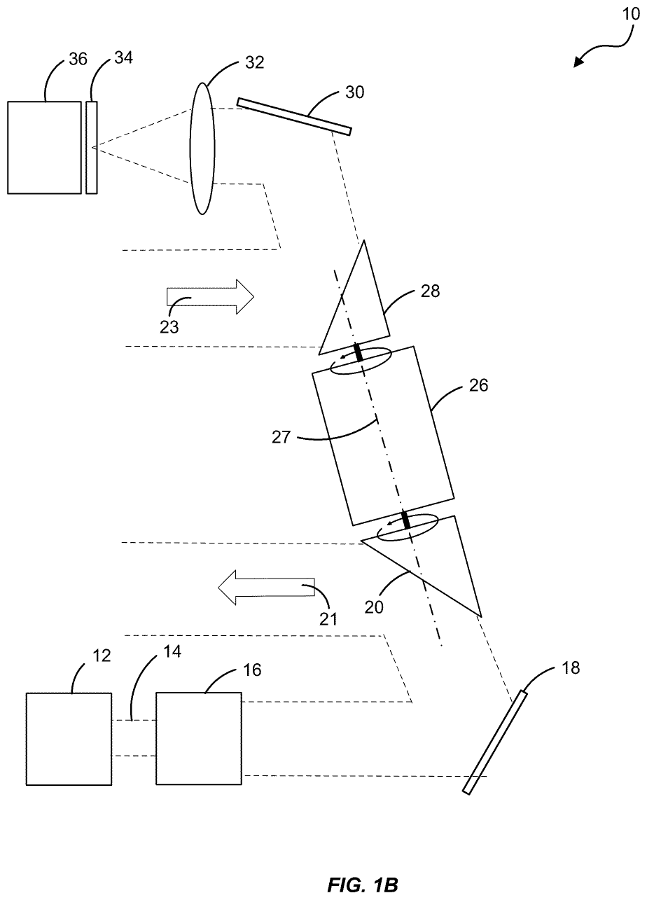

FIGS. 1A and 1B are block diagrams of an exemplary Lidar system 10. The Lidar system 10 includes a laser 12 that is operable to generate laser light 14 (e.g., continuous wave laser light) for laser detection and ranging of targets, including elevation angles of the targets, within 360° of the Lidar system 10. In this embodiment, the laser light 14 may be propagated to a beam expander 16 for reflection to a transmitter 20 (e.g., a monogon mirror) via the reflector 18. The transmitter 20 rotates about a physical axis 27 at a relatively high speed (e.g., between about 7,500 and 10,000 RPMs). Thus, the transmitter 20 is operable to direct the laser light 14 towards a plurality of targets 22 in 360° (e.g., the targets 22-1-22 N, where the reference “N” indicates an integer greater than “1” and not necessarily equal to any other “N” reference designated herein).

A receiver 28 (e.g., another monogon mirror) is configured with the transmitter 20 to rotate with the transmitter 20 at the same speed and direction as the transmitter 20. As the transmitter 20 and the receiver 28 are shaped, rotation of these devices may need counterbalancing due to the rotation speeds. Accordingly, the receiver 28 and the transmitter 20 may be configured with a counterbalancing mechanism 26 that rotates with the receiver 28 and the transmitter 20. This counterbalancing mechanism 26 may also include a motor (e.g., a perimeter driven motor) that is operable to rotate the receiver 28 and the transmitter 20 at sufficiently high speeds. Those skilled in the art should readily recognize that the disclosed embodiment is not intended to limit the scope of the Lidar system 10. Rather, the receiver 28 and the transmitter 20 may be configured in other ways as a matter of design choice, such as separating the receiver 28 and the transmitter 20 from one another and rotating each at the same speed. Additionally, the rotational speed (i.e., the angular velocity) of the transmitter 20 and receiver 28 of the Lidar system 10 may be selected as a matter of design choice based on, for example, desired range resolution of the targets, intensity of the laser light, and the like.

In this embodiment, the transmitter 20 and receiver 28 of the Lidar system 10 are configured in a bistatic arrangement. A bistatic arrangement generally refers to an optical arrangement in which the transmit and receive paths in an optical system are different. In this regard, the path of the laser light 14 transmitted to the target 22 (e.g., along the path 21) differs from the path of the laser light received from the target 22 (e.g., along the path 23). The rotations of the transmitter 20 and the receiver 28 of the Lidar system 10 may cause an angular displacement in a detector portion of the Lidar system 10 that may be used to detect a range to the target 22 and an angle 23 of the target 22 from the Lidar system 10. For example, a processor 36 may determine a range to the target 22 and an angle of the target 22 from the Lidar system 10 by using an angular displacement between the path of the laser light and the receiver 28 that arises from an angular velocity of the transmitter 20 and receiver 28.

In any case, the laser light 14 is continuously transmitted from the transmitter 20 along the path 21 as the transmitter rotates about the physical axis 27, impinging targets 22 along a circular path 24. The receiver 28 receives laser light returns 14 from the targets 22 in the circular path 24 along the path 23. These returns are reflected from the receiver 28 to a mirror 30, which in turn reflects the laser light 14 through a lens 32 for focusing on to an event camera 34.

An event camera, also known as a neuromorphic camera, is an imaging sensor that responds to local changes in brightness. Event cameras do not capture images using a shutter as conventional frame cameras do. Instead, each pixel inside an event camera operates independently and asynchronously, reporting changes in brightness as they occur, and remaining inactive otherwise. The event camera 34 has a plurality of pixels with each pixel being triggerable by photon flux changes. When laser light 14 returns from the target 22, the laser light triggers one or more of the pixels in the event camera 34. The event camera 34, in turn, produces event data indicating the photon flux change in the pixel(s) and the coordinate(s) of the pixel(s) in the event camera 34.

The processor 36 is operable to process the event data from the event camera 34. The processor 36 calculates a range and an angle to the target 22 using an angular displacement between the path 23 and the receiver 28 that arises from the first rate of rotation for the transmitter 20 and the receiver 28 and, in part, from the event data of the pixel(s) based on a direction of the first path 21 at a time of a photon flux change and a pixel coordinate of the pixel(s).

FIG. 1B is a block diagram of another view of the Lidar system 10 rotated about the physical axis 27. Again, the generated laser light leaves the transmitter 20 along the path 20. Laser light returns from a target (not shown) and received along the path 23 by the receiver 28. As can be seen with this rotation, the transmitter 20 and the receiver 28 are precessing the fast scan about a slow scan axis. This conical scanning “dual monogon” is configured at an angle, so that the elevations relative to a zenith range are between a minimum and a maximum value. By rotating the scanning mounting structure about the zenith, all ranges of elevation between the minimum and maximum values can be interrogated at all azimuthal angles. Other exemplary embodiments and details are shown and described below.

Additionally, while the embodiments herein are amenable to continuous wave (CW) laser light, the embodiments herein are not intended to be limited to such. For example, the laser 12 may be configured to generate pulsed laser light, modulated laser light, or even modulated pulsed laser light depending on a desired application. And the rate of rotation of the Lidar system 10 may be selected as a matter of design choice.

In whatever the configuration, the Lidar systems herein include any device, system, software, or combination thereof comprising a bistatic optical arrangement that rotates about an axis to transmit laser light to one or more targets, and to receive resulting reflected and/or backscattered laser light from the one or more targets to determine a range and an angle of the one or more targets based on the angular displacement between the transmitter portion of the optical arrangement and the receiver portion of the optical arrangement. In other words, both the transmitter portion and the receiver portion of the optical arrangement rotate about a physical axis, either individually or as part of a single unit, to transmit and receive laser light for determining the range and angle of a target based on the angular displacement between the path of laser light 14 and the receiver 28 resulting from the rotation of the receiver 28 during the traversal of laser light 14 from the transmitter to a target 22 and back to the receiver 28 and, in part, from event data of at least one of the pixels based on a direction of the path at a time of a photon flux change and a pixel coordinate of the at least one pixel.

The laser 12 is any device, system, software, or combination thereof operable to generate laser light. Many of the embodiments shown and described herein may be particularly well-suited for performing Lidar analysis with continuous wave (CW) laser light. Accordingly, with many of the embodiments herein, the laser 12 may be configured to generate CW laser light. However, the embodiments are not intended to be limited to any particular form of laser light as, in some embodiments, the laser 12 may pulse laser light. The wavelength of the laser light may be selected as a matter of design choice. In some embodiments, the Lidar system 10 may comprise a plurality of lasers 12 that generate light at different wavelengths. For example, one laser may generate a first wavelength, a second laser may generate a second wavelength that differs from the first wavelength, a third laser may generate a third wavelength that differs from the first and second wavelength, and so on. Generally, the number of lasers 12 and their wavelengths may be selected as a matter of design choice.

The imaging may be performed by any device, system, software, or combination thereof operable to image the laser light 14 received by the receiver 28. For example, the event camera 34 has a plurality of pixels, with each pixel being triggerable by photon flux changes. Alternatively or additionally, however, the Lidar system 10 may include one or more detectors configured in one-dimensional detector arrays and/or two-dimensional detector arrays. Examples of detector elements employed by the detectors may include camera pixels, photon counters, PIN diodes, Avalanche Photo Detectors (APDs), Single Photon Avalanche Detectors (SPADS), Complementary Metal Oxide Semiconductors (CMOS), Position Sensitive Detectors (PSDs), or the like. In some embodiments, the Lidar system 10 may include additional optical elements including focusing elements, diffraction gratings, transmissive scanners, and the like. Where multiple laser wavelengths are used as part of laser 12 or lasers 12, the Lidar system 10 may include multiple arrays of detectors, each with different wavelength sensitivities. In some embodiments, dichroic mirrors, spectral filters, and/or polarization filters may be used to route light to multiple arrays of detectors.

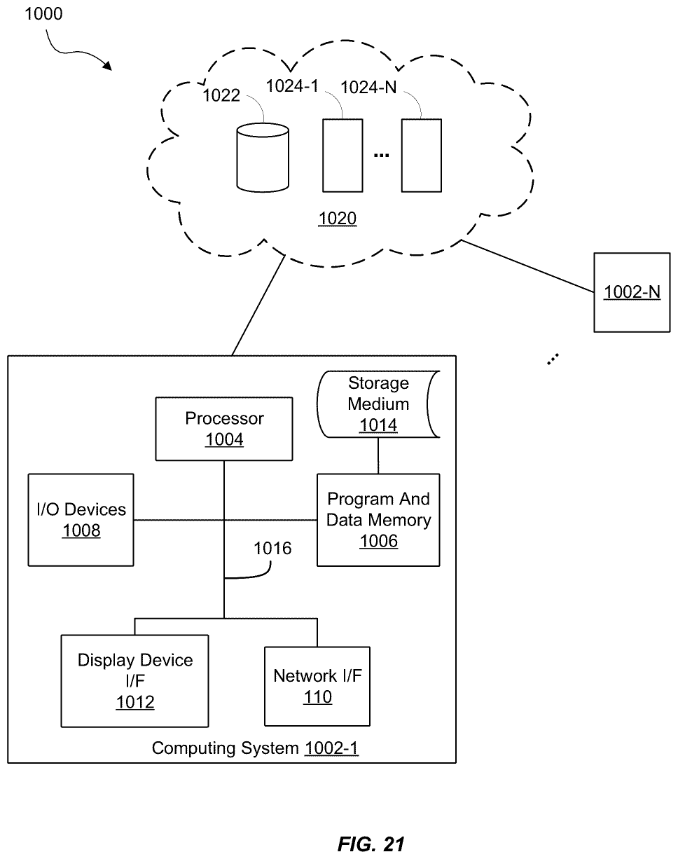

The processor 36 is any device, system, software, or combination thereof operable to process signals to determine a range and an angle of the target 22 based on the angular velocity of the reflective elements 20 and 28. One exemplary computing system operable to perform such processing is shown and described in FIG. 21. Examples of the target 22 include hard targets (e.g., planes, cars, people, and other objects) and soft targets (e.g., particulates, clouds, vapors, and/or other distributed volumetric scatterers). And, the reflective elements 20 and 28, while both being configured as monogon reflective elements, may comprise shapes and angles of reflection that are selected as a matter of design choice.

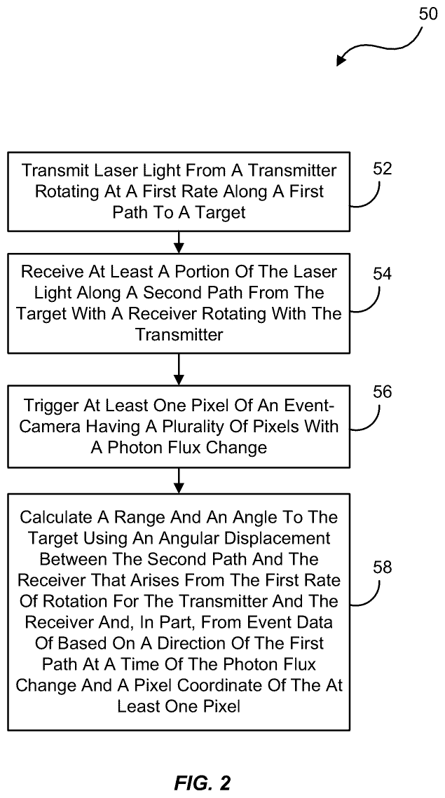

FIG. 2 is a flowchart of an exemplary process 50 of the Lidar system 10 of FIGS. 1A and 1B. In this embodiment, the Lidar system 10 is initiated when the transmitter 20 and the receiver 28 are rotating. From there, the laser 12 generates the laser light 14 which is transmitted from the transmitter 20, at a first rate of rotation of the transmitter 20 and the receiver 28, along a first path to a target 22 (e.g., path 21), in the process element 52. When the laser light 14 returns from the target 22, the receiver 28 receives at least a portion of laser light along a second path (e.g., path 23), the receiver 28 rotating with the transmitter 20 at the same rate of rotation, in the process element 54. The laser light returns are directed to the event camera 34 which trigger at least one of the pixels of the event camera 34 with a photon flux change, in the process element 56. From there, the processor 36 may calculate a range and an angle to the target 22 using an angular displacement between the second path and the receiver 28 that arises from the first rate of rotation for the transmitter 20 and the receiver 28 and, in part, from event data of at least one of the pixels based on a direction of the first path at a time of a photon flux change and a pixel coordinate of the at least one pixel, in the process element 58.

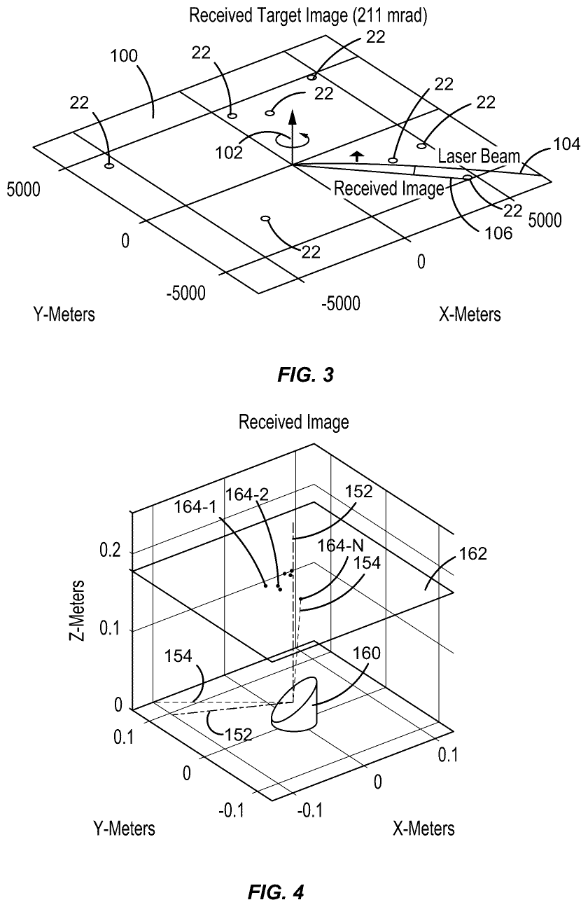

FIG. 3 illustrates how a high-speed scanner of the embodiments herein can detect the position of targets 22 within a plane 100. A transmitted laser beam 104 is rotated around a central axis 102, and the path of the laser beam 104 occurs at one moment in time. Because of the relatively high rotation rate of the scan, the laser beam 104 has a curved path at any given time. Targets 22 are exemplarily illustrated as being distributed within the scanned plane 100. The received image 106 exemplarily shows the path of laser light reflected from a target 22 back to scanner (i.e., the transmitter 20 and the receiver 28, not shown). Because of the speed of light, the received illuminated image of the target 22 reaches the scanner after it has rotated by a deflection angle that is proportional to the product of the rotational rate of the scanner and the optical time of fight to the target 22 and back. The processor 36 uses this angle of image deflection to measure the range to the target 22 and the angle of the scanner when the image is received to determine the direction towards the target 22. The optical design of the scanner provides a natural image orientation from which each of the target positions may be derived.

With the introduction of the event camera 34, the Lidar system 10 improves wide area threat detection (WATD) sensing with the ability to detect relatively small objects within a larger radius around the sensor. The sensing approach is not necessarily intended to provide high resolution imagery. Rather, the Lidar system 10 is capable of optically interrogating large volumes of space in a particularly efficient manner. Some of the advantages of the sensing approach include: continuous coverage along two dimensions while still scanning along a third; enabling the use of CW lasers' higher average power sources and acceptable efficiency for mobile platforms; no range-wrapping issues that can arise for high repetition Lidars with long ranges; and leveraging mature commercial products to enable low-cost solutions and rapid system development.

FIG. 4 provides a simplified view of a scanner 150, in one exemplary embodiment. The scanner 160 is illustrated in a monostatic arrangement to show the operating characteristics of the transmitter 20 and receiver 28 of FIGS. 1A and 1B. In this embodiment, a transmitted beam 152 is directed down a rotational axis of a monogon reflector 160 (e.g., a single wedged shaped reflector with reflective surface at 45 degrees relative to the rotation axis). As the monogon reflector 160 rotates, the transmitted beam 152 is scanned at the same rotation rate as the monogon reflector 160. The monogon reflector 160 rotates counterclockwise around an upward directed axis. Light that has been reflected from targets returns to the monogon reflector 160 on a path 154 that is lagging the rotation of the monogon reflector 160. After reflection from the monogon reflector 160, the received light is deflected from the rotation axis in a direction that leads the transmit direction by approximately 90 degrees with a deflection magnitude that is proportional to the target range. The plane 162 above the monogon reflector 160 can be interpreted as an image plane, though the imaging optics are not shown for case of understanding. Illuminated target images 164-1-164-N are formed at different locations on the image plane 162 to form a spatial pattern.

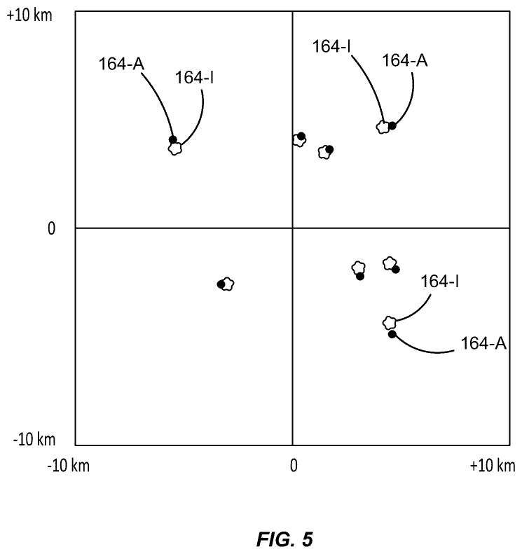

The spatial pattern of the targets 164 on the image plane 162 (i.e., after a 90-degree rotation and a small angle correction that is linear with the azimuth) is a scaled version of the actual physical pattern of targets 164 in the scanned plane. FIG. 5 shows the scaled and rotated image pattern of target images 164-I (“I” representing imaged targets) in the image plane 162 overlaid on top of the actual positions of the target locations (“A” representing actual targets). Some small deviations of the described mapping can lead to relatively small errors in the actual target positions, but the pattern of target images 164-I viewed by the sensor is a rotated view of the actual physical target locations and provides a mostly accurate sensor approach.

The performance of the sensing approach may be constrained by imaging resolution and achievable rotation rates. The radial displacement magnitude of a target image 164-I on the image plane 162 is approximately given by:

$$s = {f}_{e f f} ( 2 π Γ ) ( \frac{2 R}{c} ) ,$$

where f_{eff} is the effective focal length of the imager, Γ is the rotation rate of the monogon reflector 160 in Hz, R is the range to a target 164, and c is the speed of light. There can be some minor corrections to this expression for longer ranges, but this expression is generally intuitive. The radial image displacement is proportional to the target range. At relatively long ranges, and with sufficiently small transmitter divergence, image spot sizes may be limited by diffraction and have a diameter approximately given as:

$$Δ s \approx \frac{2.4 λ}{D} {f}_{eff} ,$$

which corresponds to a range resolution of

$$Δ R \approx \frac{2.4 λ c}{4 π Γ D} .$$

To illustrate, if the monogon reflector 160 has a 2″ diameter and rotates at 250 Hz, and if the transmitter wavelength is 1.55 μm, then the resolution may be as good as ΔR≈6.7 m. While this resolution is based on the diffraction limited size of the target image, precision in location is generally substantially better than the size of the image.

Given the limits on resolution, rotational speed, and size of the monogon reflector 160 come into question in design choices. In several finite element method (FEM) analyses of different monogon reflector structures, centripetal forces generally result in mechanical deformation resulting in optical distortion. Once a threshold for number of tolerable waves of distortion is selected and a general physical structure is chosen, the limits on the rotational speed and size of the monogon is generally proportional to 1/(ΓD), suggesting that the resolution limit is fixed for the design regardless of its scaled size. Given this insight, one might suggest reducing the rotation rate and increasing the diameter to improve optical power collection while operating at the limit for optimal resolution. This is generally a good strategy up to a point.

However, at some monogon diameter, optical turbulence becomes an actual limit on image and range resolution instead of diffraction from the aperture. Additionally, at larger sizes, the fabrication and balancing of monogon reflectors becomes more challenging, and possibly dangerous. The mass of the monogon reflector 160 scales as the third power of the monogon diameter. More importantly, the moment of inertia tensor elements scale as the 5^{th} power of the monogon diameter. While a good monogon reflector design aims to zero-out off- axis tensor elements to align the principal axis of inertial with the monogon rotation axis, this can become increasingly difficult with larger monogon reflectors. Additionally, with larger masses, the monogon motor shaft should be stiffer to avoid inducing resonances in the system that preclude spinning at the required spin rates. Good design of a monogon reflector generally includes a balance wheel and internal material removal to design for both static and dynamic balancing.

In one embodiment, a monogon reflector is comprised of two 45-degree wedge mirrors with balance wheels connected to opposing sides of a single shaft of a motor system. While this dual monogon reflector is constructed to project an illumination beam in a flat plane orthogonal to the rotational axis of the monogon reflector, dual monogon reflectors can be fabricated more generally to provide a conical scan.

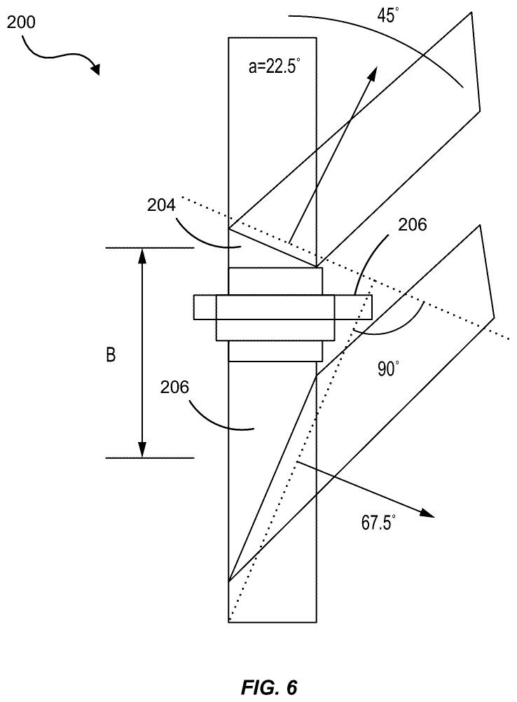

For example, FIG. 6 shows a scanner 200 comprising a motor/balancing module 206 configured with a transmit mirror 202 and a receiver mirror 204 at complementary angles. That is, the transmit mirror 202 and the receiver mirror 204 have surface normals of the two mirrors being orthogonal. This arrangement provides a conical laser scan at twice the angle between the mirror surface normal and the rotational axis. Because the two mirrors 202 and 204 are separated by a bistatic separation B, it would be expected that parallax could have an effect on target image positions when targets are in nearer ranges.

The mapping of target range to image plane position for a conical scan may be calculated as a function of the system parameters. For example, if a target is positioned at some distance R and angle θ within a conical scan in the x-z plane of the Lidar system 10 (e.g., where z is the fast scan axis), the target will come to focus on a position (xᵢₘ, yᵢₘ) in the image plane given by

$${x}_{i m} = {x}_{i m , 0} cos ( θ ) - {y}_{i m , 0} sin ( θ ) ,$$

$$and {y}_{i m} = {x}_{i m , 0} sin ( θ ) + {y}_{i m , 0} cos ( θ ) ,$$

where x_{im,0} and y_{im,0} are “derotated” coordinates for a target along the θ=0 path as follows:

$${x}_{i m , 0} = - f \frac{sin ( 2 α ) ( B cos ( δ ) + R ( 1 + cos ( 2 α ) cos ( δ ) - 2 {cos}^{2} ( α ) {cos}^{2} ( δ ) ) )}{B cos ( 2 α ) + R ( {cos}^{2} ( 2 α ) + {sin}^{2} ( 2 α ) cos ( δ ) )} ,$$

$$and {y}_{i m , 0} = f \frac{+ R ( {sin}^{2} ( α ) + {cos}^{2} ( α ) ( 2 cos ( δ ) - 1 ) ) - B}{B cos ( 2 α ) + R ( {cos}^{2} ( 2 α ) + {sin}^{2} ( 2 α ) cos ( δ ) )} sin ( 2 α ) sin ( δ ) .$$

The time of the illumination of the target relative to the start of a single rotational scan may be given by:

$${t}_{i m} \approx \frac{θ}{2 π Γ} ,$$

where the time of flight is neglected because it is small relative to timing resolution. In these expressions, R is the distance to the target, α is the surface normal angle for the transmitter monogon (receiver angle is complementary), δ is the monogon rotation during the time of flight to a target and back at a range

$$R ( δ = \frac{4 π R}{c} Γ ) ,$$

f is the imaging focal length, and B is the bistatic separation between transmit and receiver monogon centers.

For sufficiently small angles δ, the image coordinates are approximately given by the simplified unrotated parameters of:

$${y}_{i m , 0} \approx f sin ( 2 α ) sin ( δ ) \approx \frac{4 π f Γ}{c} R sin ( 2 α ) ;$$

$$and {x}_{i m , 0} \approx - \frac{f B}{R} - \frac{{y}_{i m}^{2}}{f} .$$

The term “R sin (2α)” provides the intuition that for conical scans, the radial displacement at the image plane is approximately the projected target range along the plane that is normal to the fast scan axis.

As an illustrative case, where α=π/4, B<<R, and δ is small, the image displacement in the y direction is the same as in the monostatic case:

$${y}_{i m} \approx f ( \frac{4 π Γ}{c} ) R ,$$

but the image coordinate in the x direction now is given by:

$${x}_{i m} \approx - \frac{{f}^{B}}{R} - \frac{{y}_{i m}^{2}}{f} .$$

The first term of this coordinate

$$( \frac{f B}{R} )$$

is a parallax displacement term and has no dependence on the rotation rate. At sufficiently long ranges, the system behaves similarly to a monostatic system. However, at short ranges, this parallax moves the return image far away from the region that would be used to image distant objects. This has the added advantage that near objects, which are bright and out of focus, will not interfere with the ability to image distant objects.

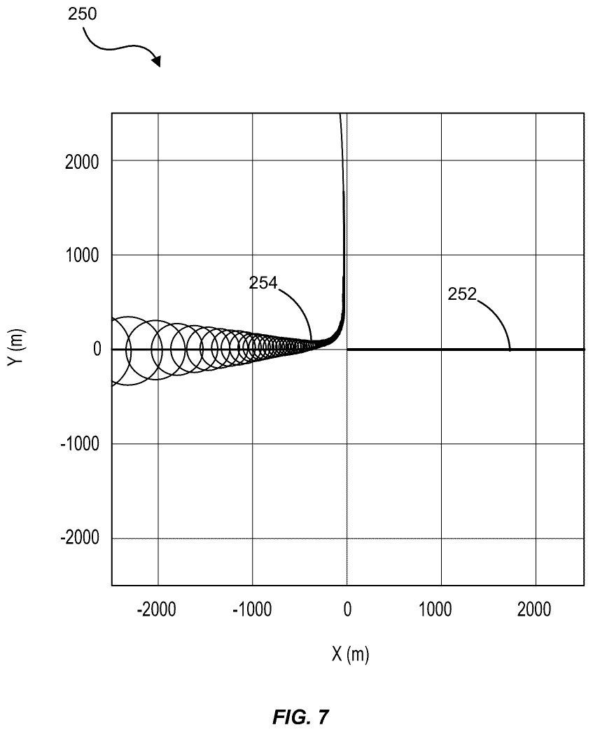

FIG. 7 is a graph 250 illustrating an array of targets with increasing ranges. The line 252 corresponds to an array of targets with increasing ranges along the x-axis in meters. The images of the array of targets that are expected for the bistatic Lidar system 10, after being scaled by a factor of

$$( \frac{4 π Γ}{c} f )$$

to match the target space, is illustrated with 254. The target images are rotated by 90 degrees at long ranges, but otherwise roughly correspond to actual physical locations. However, for near ranges, the target images are out of focus and aligned along the negative x-axis. It should be noted that the mapping of the line 252 to the scaled image is nearly instantaneous on the relevant time scales for the camera imager, and a line of targets along a rotated radial path would lead to scaled images with an equivalent rotation about the center of the figure.

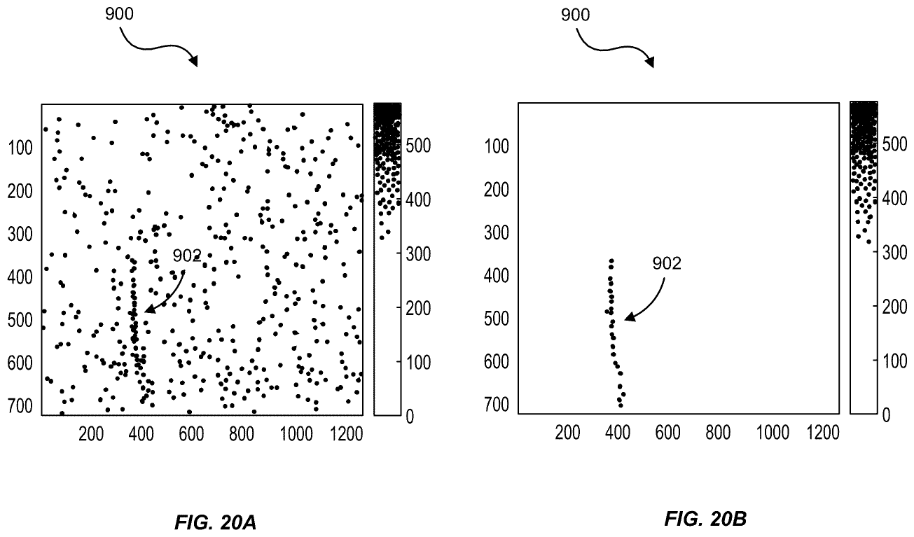

Several tests were conducted with the embodiments herein. In one test, the Lidar system 10 illuminated a distant earthen berm with a 1-watt 532 nm laser while using a single-photon sensitive camera. Tests were performed in the evening to aid in the alignment of the laser to an earthen berm. Because of a slight clocking error previously measured in the lab between the transmit and receive monogon, there was a mapping distortion of the pixels to physical position, but the berm's two-dimensional location, along with several tree trunks, was clearly represented on the image. On a log-scale, even atmospheric back-scatter could be detected. An example of such is shown in FIGS. 20A and 20B, illustrating an image of the earthen berm before filtering (FIG. 20A) and after filtering (FIG. 20A).

The bistatic arrangement of the Lidar system 10 has several significant advantages compared to monostatic prototypes, including: no internal backscattering onto the image plane, significantly reducing speckle noise and further increasing ranges of detection; symmetry across the motor makes balancing somewhat simpler; polarization optics are not required, reducing the volume by somewhere between 50% and 30%, reducing parts, and lowering costs; a simpler receiver train resulting in much lower optical loss on both the transmit and receive side of the Lidar system 10; and the laser 12 does not need to be polarized, permitting use of efficient high-power Raman Lasers (e.g. 100 W-200 W).

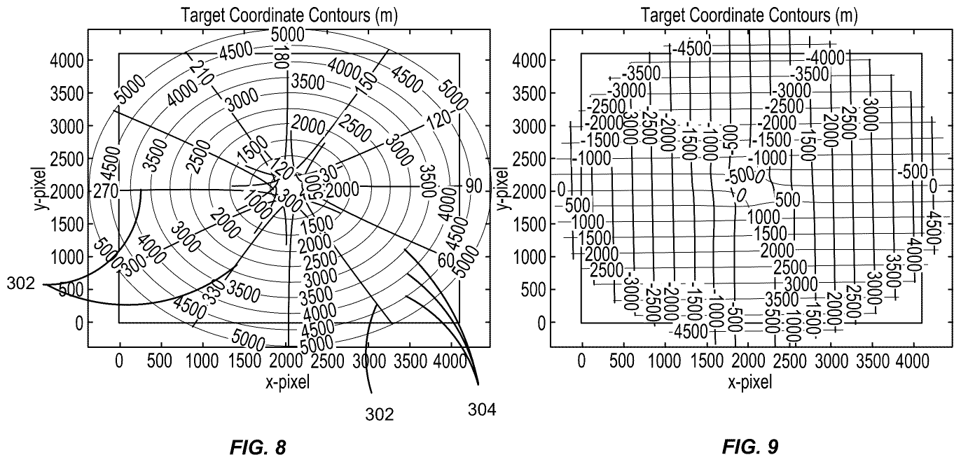

Using a 4096×4096 camera with 1.1 um pixels, an 8″ focal length, an 8″ bistatic separation and a 7,500 RPM bistatic scanner, FIGS. 8 and 9 illustrate an ideal mapping of pixels to target physical position, projected into the scanning plane. In FIG. 8, the lines 302 of the graph 300 indicate an angle to the target in increments of 30 degrees, and the elliptical lines 304 correspond to successive ranges in 500 m increments. At relatively short ranges, the parallax term becomes significant and results in double valued pixel mapping to ranges. FIG. 9 shows a mapping of pixels to cartesian coordinates of a detected target (i.e., in the projected plane of the scanner) where the units associated with the position are in 500 m increments in both the horizontal and vertical coordinates. At large ranges, mappings of pixels to physical coordinates are relatively uniform and linear, while distortions occur at shorter ranges due to parallax.

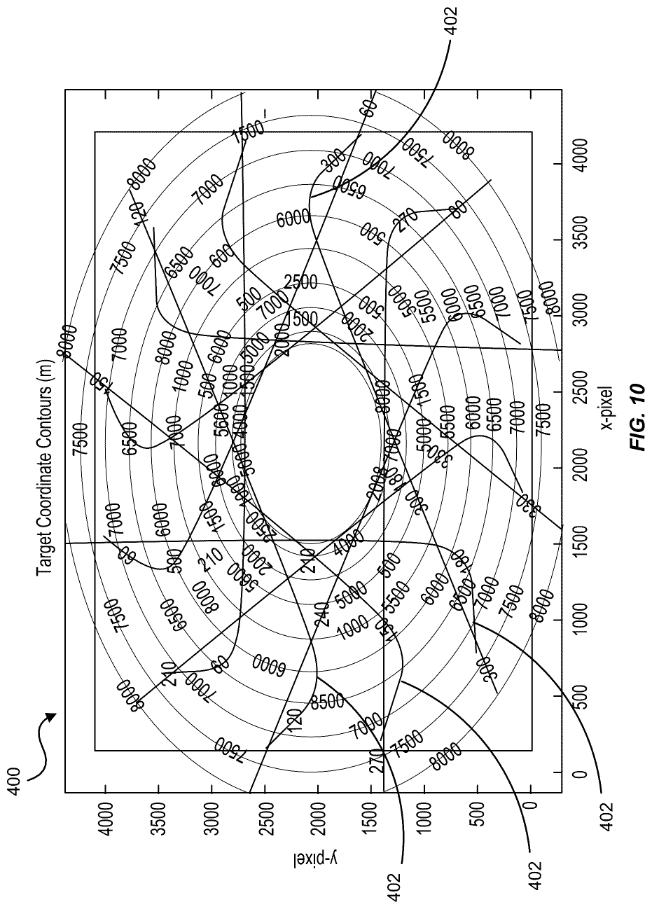

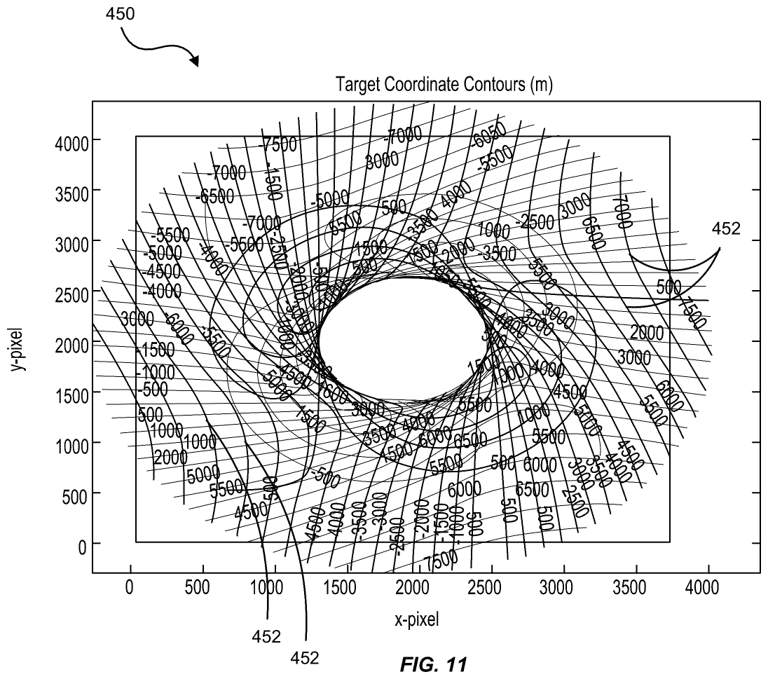

In some instances, fabricating a bistatic scanner system with ideal angles presents a challenge. For example, on one dual monogon scanner, a clocking error (i.e., a relative rotational error between the transmit and receive monogon about the rotation axis) was measured at about −8.47 mrad, and an angle tilt error of the top monogon away from the rotation axis of was measured at about 1.72 mrad. These fabrication errors can lead to distorted pixel mappings, as shown in FIGS. 10 and 11 (i.e., for the same idealized system leading to the mapping in FIGS. 8 and 9).

From this distorted mapping, it can be observed that targets observed at 500 m, for example, will appear at nearly the same pixel location as a target at 6 km, but at a different angle from the sensor. The time of target illumination, if resolved would, remove the pixel mapping ambiguity, though this is challenging information to obtain with conventional framing cameras because enormous frame rates may be needed (e.g., in the MHz class).

To illustrate, FIGS. 10 and 11 shows the curves 402 and 452, respectively, which correspond to regions of the image plane that may be illuminated by target angles as the scanner moves through 30 degree scanning increments. For this example, with a 7,500 RPM scanner, capturing separate images for each 5-degree sweep of the volume would require a 32.4 MHZ camera frame rate using a conventional camera. With the number of pixels required for providing desired range resolutions, high camera frame rates for resolving target position ambiguities using a 2D image plane would be extremely difficult. Using an event camera, such as event camera 34 of FIG. 1, pixel mapping ambiguity can be resolved.

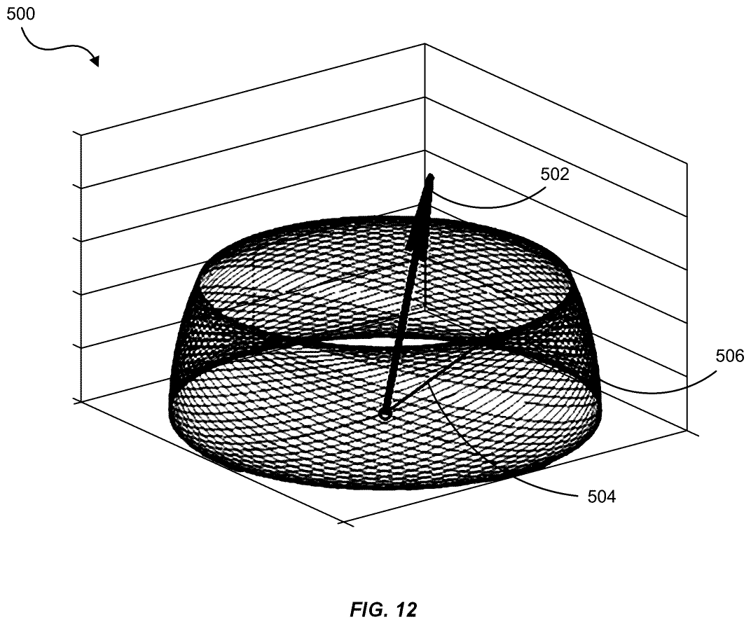

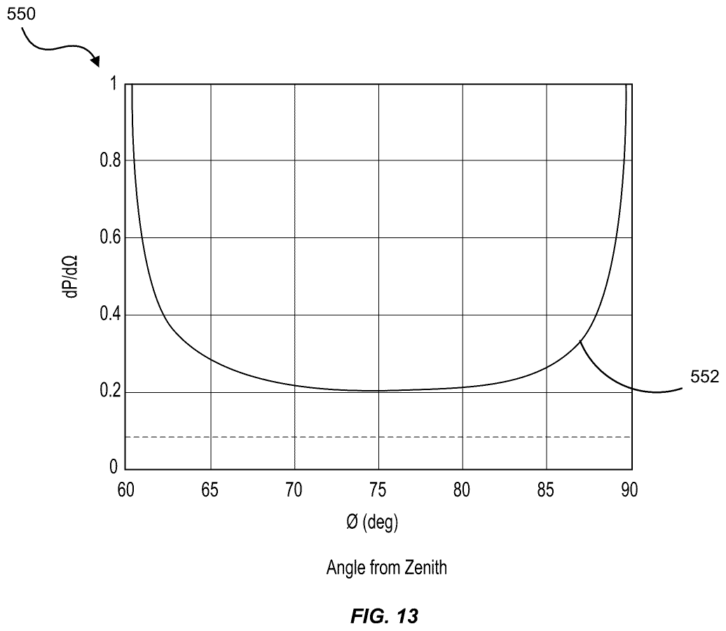

In some embodiments, the Lidar system 10 of FIG. 1 is designed to provide elevation coverage by using a conical scan that precesses around a vertical axis. FIG. 12 shows a pattern 506 formed by scanning the laser light 14 from the laser 12, scanning at a 75-degree processing angle (shown by the arrow 502) to a fast scan axis 504, while the fast scan axis maintains an angle of 15 degrees with the vertical axis. That is, the processing scan angle 502 slowly precesses around fast scan axis 504. Using these parameters, the power per solid angle is enhanced at the horizon and at thirty degrees above the horizon. FIG. 13 is a graph 550 that shows the power 552 per solid angle as a function of the angle from zenith.

These processes of detecting targets are improved with the introduction of the event camera 34. The event camera with a two dimensional (2D) image plane in the wide area Lidar system 10 provides certain advantages and improvements that include: greater resilience to solar background noise resulting in longer range detection capability; elimination of double value mapping ambiguities in bistatic systems with 2D framing camera detection; noise reduction by utilizing timestamp information; elevation coverage extension methods; and simpler and faster target detection than framing cameras with image processing.

The event camera 34 reports “events” associated with changes in optical power on a pixel that exceeds a threshold. The event data includes generally includes pixel coordinates and time stamps for the event. Thresholds for change rates can be tuned, and detection of very high bandwidth events are possible. Event triggers can also be caused by solar background changes or noise. Thus, pixel events that do not occur at times corresponding to laser illumination can be rejected from consideration. Candidate pixel events and their time stamps can be used to directly look up relative spatial coordinates for target queuing. Some event cameras may also report a magnitude of the change, pixel intensity, or whether the event- triggering power change was positive or negative.

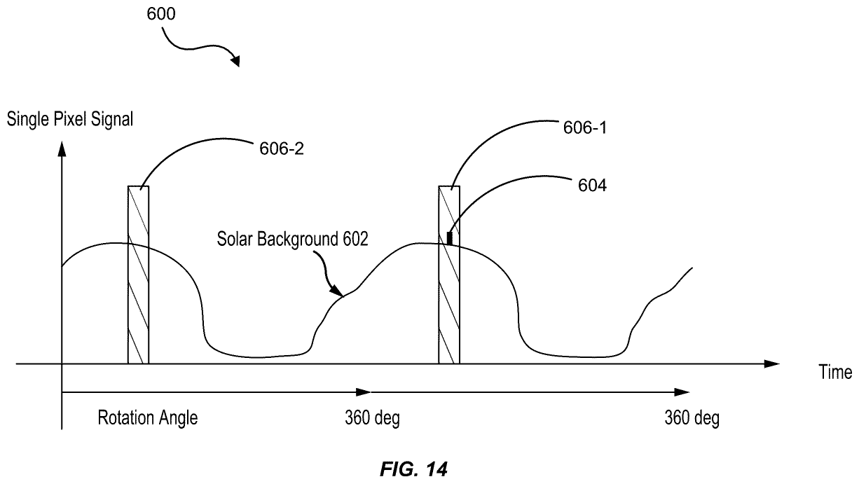

FIG. 14 is a pixel intensity vs. time graph 600 illustrating one exemplary optical signal that a single pixel on a 2D image plane of the event camera 34 would observe during two full 360-degree laser scans with a single target in view. Even with a narrow spectral filter, some solar background 602 may still be detected during the day, resulting in a background signal with an intensity that depends on the look angle. If the laser 12 illuminates a distant target resulting in an image at the pixel, it may result in a rapid but small signal increase during one time per laser rotation (i.e., times 606-1 and 606-2), as illustrated with the target signal 604. A normal 2D framing camera would be limited in detecting small signals due to the accumulated solar background 602 during camera image exposure times. But, as the time for this solar background does not occur at the expected time of the laser light returns, any event data associated with those times can be removed. In some embodiments, the flux change triggering of the event camera can be tuned so that changes in the solar background 602 during the rotational scan are insufficient to trigger the pixel. But a very short duration signal from a target illumination (i.e., target signal 604) will trigger the pixel. Thus, the event data from that pixel is processed when the event camera is triggered by the expected time for the lidar return.

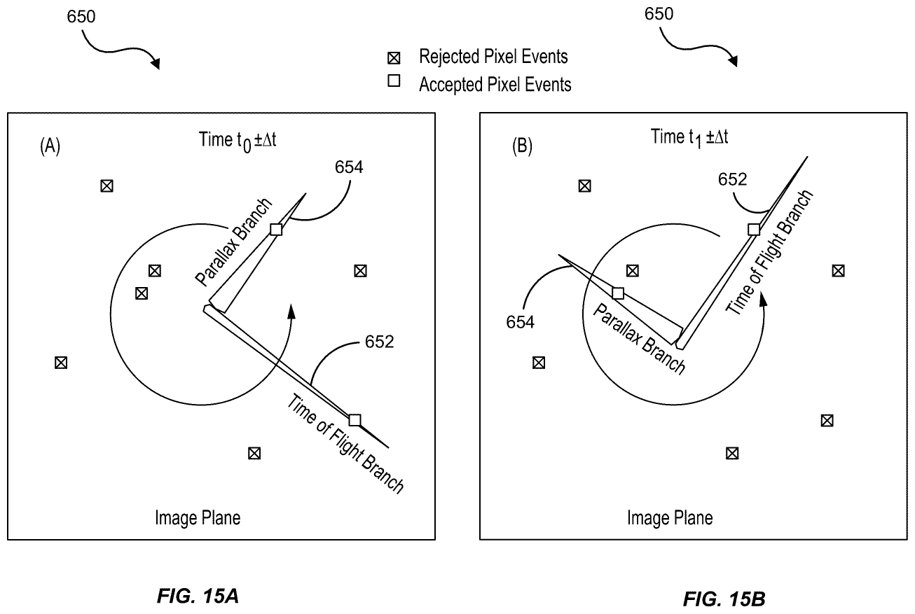

FIGS. 15A and 15B illustrate exemplary an image plane 650 at two different times. At both times, a “time of flight” branch 652 and a “parallax” branch 654 is shown. These are the regions on which laser illuminated pixels can be observed. Any pixels triggered outside of either region within a short time span (±Δt) are rejected as noise. The time stamp of each event is associated with the angle to the target, and the mapping to the range to target is obtained for that specific time and angle. There is no ambiguity in the target range or angle with the time stamp from a pixel event. Any pixel coordinates that are not within a pixel region near the parallax branch 654 or time of flight branch 652 can thus be rejected as noise. Additionally, pixels that repeatedly result in triggers and rejected noise may be eliminated from consideration.

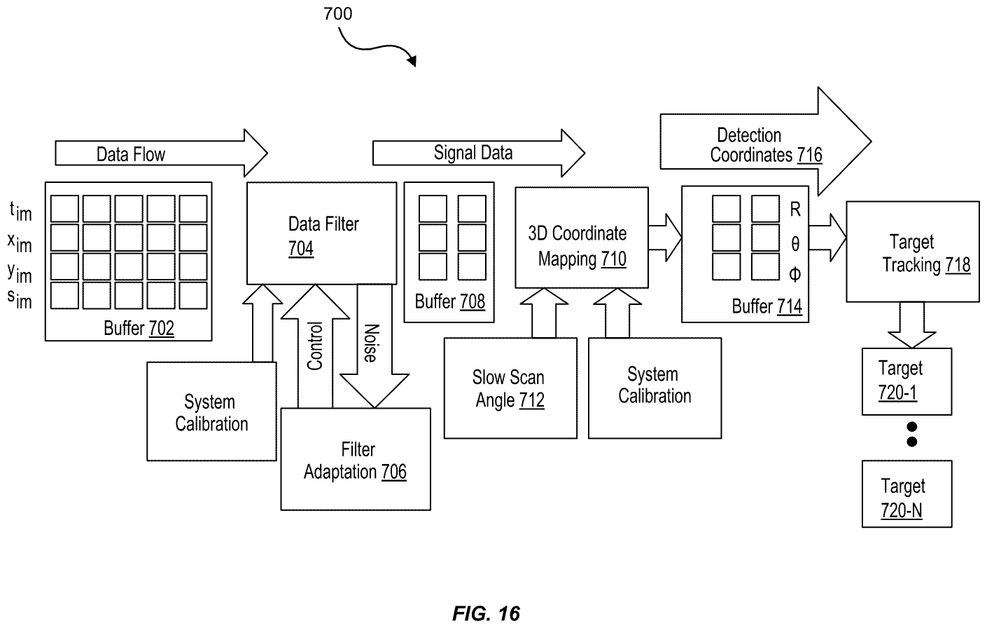

FIG. 16 shows the data flow from pixel trigger events in one exemplary embodiment. Each pixel trigger event results in event data that is a data set with the following parameters:
tᵢₘ represents the event time;
xᵢₘ represents the horizontal pixel coordinate; and
yᵢₘ represents the vertical pixel coordinate.

In some embodiments, an additional parameter sᵢₘ may be used to represent a strength of the pixel signal. For example, sᵢₘ may indicate whether the change is positive or negative, or in some cases it may also indicate magnitude of change. This event data from the camera enters a buffer 702 and is processed by a data filter 704. The data filter 704 removes events that should not be considered for potential target hits. Based on system calibration, the time stamp of the event can be used to determine valid pixels that can be illuminated by the laser 12 at that time. Other pixel events are rejected. As an example, for a pixel with event data xᵢₘ, yᵢₘ, tᵢₘ, the data filter 704 may compute a relative time tᵣₑₗ=tᵢₘ−t_{scan}, where t_{scan} is a recent trigger from when the scanner was directed at an angle θ_{scan}=0. The data filter 704 may also compute the laser azimuthal scan angle for the event as θᵢₘ=tᵣₑₗ(2πΓ), with Γ being the scanner rotation rate in Hz. Then, the data filter 704 may compute derotated pixel coordinates of the event as follows:

$${x}_{im , 0} = cos ( {θ}_{im} ) {x}_{im} + sin ( {θ}_{i m} ) {y}_{im} ,$$

$$and {y}_{i m , 0} = - sin ( {θ}_{i m} ) {x}_{i m} + cos ( {θ}_{i m} ) {y}_{i m} .$$

Compare the pixel-space coordinates x_{im,0} and y_{im,0} to a previously calculated pixel mask region (e.g., from system calibrations). If the derotated pixel coordinate is outside the region, it may be rejected as a false hit and rejected. If the events include parameters to indicate the direction of change for a pixel, rising events may be provisionally accepted and then confirmed if a falling event occurs within a short pre-determined delay threshold.

Various additional filtering functionality may be adapted (e.g., via filter adaptation 706 based on statistical analysis of previous event statistics and operational scenarios). For example, pixels that consistently provide events that are not within the rotating time of flight branch 652 or parallax branch 654 may be labeled as “bad pixels” and eliminated from future processing. The statistical analysis of potentially bad pixels may also include analysis of whether the pixel triggers have periodicity matching the scanner rotation period. Pixel event periodicity matching the scanner periodicity may indicate passive background images resulting in triggers, but the pixel itself may be performing adequately.

Depending on the geometry of the scan (e.g., if a portion of the scan has been determined to be hitting the ground or buildings), time stamps may be used to reject some pixel events corresponding to laser illumination directions with known obscurations. Rejected pixel events from further processing may then be based entirely on the timestamp without regard to the actual pixel coordinates.

In some embodiments, a dynamic “bad pixel” register may be maintained by adding a “false hit” count for each pixel on every event that cannot be attributed to laser illumination, and by subtracting a false hit count at a regular interval if the false count is greater than one. Pixels having a false hit count exceeding a threshold are eliminated from further processing.

After initial filtering, pixel events associated with laser illumination are passed through a buffer 708 for 3D coordinate mapping 710. In the coordinate mapping 710, the 3D spatial coordinates corresponding to the pixel event are initially calculated within a coordinate system of the scanner at the time of the pixel event. During the data filter step 704, an azimuthal angle may have already been calculated (θᵢₘ). For embodiments with a conical scan, the laser scans a constant polar angle ϕᵢₘ=2α relative to the scan axis. As described earlier, derotated coordinates can be calculated from the pixel event coordinates, as follows:

$${x}_{im , 0} = cos ( {θ}_{im} ) {x}_{im} + sin ( {θ}_{i m} ) {y}_{im} ,$$

$$and {y}_{i m , 0} = - sin ( {θ}_{i m} ) {x}_{i m} + cos ( {θ}_{i m} ) {y}_{i m} .$$

A previously tabulated map of target range Rᵢₘ(x_{im,0}, y_{im,0}) may then be used to look up a target range. The tabulated range function includes effects of scanner fabrication errors such as clocking errors between the two monogons and angle errors in the surface normal relative the scanning rotation axis.

In some embodiments the scanner axis of rotation may be precessing or rotating about a slow rotation access or may be on a moving platform resulting varying orientations. Accordingly, the 3D coordinates of the calculated target location may then be rotated into a reference coordinate frame 710 for the system via the slow scan angle 712. Though the output detection coordinates are illustrated in polar coordinates (714 and 716), the final output may be provided in cartesian coordinate or any coordinate or coordinate reference system suitable for downstream processing or system integration. In some embodiments, the target coordinates in the scanner frame are converted to cartesian coordinates, and a rotation matrix (e.g., calculated from measured orientations of the scanner to a known reference frame) is used to calculate the target coordinates in the known reference frame.

Furthermore, in some embodiments, the stream of target coordinates may be used to track one or more targets. For example, this process may first act to hypothesize potential target velocities upon detection. Through multiple detections, the target tracking process 718 may hypothesize likely partitioning of the detections into one or more target detection sequences. Detection sequences may be processed with Kalman filters to improve associations of subsequent detections with each individually tracked target process. Each tracked target 718 process may be used to project target locations at later times, and to queue other systems to be pointed at targets (e.g., radar and defense systems).

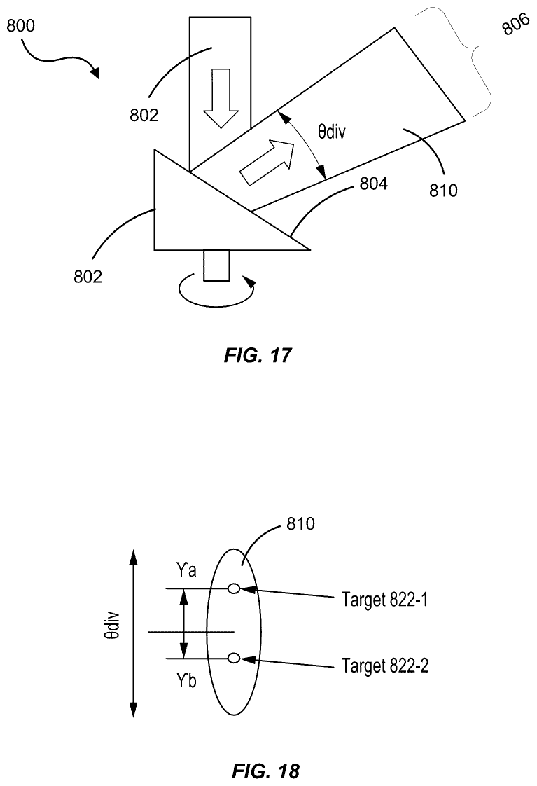

In embodiments with high temporal resolution event stamps, the elevation on each fast scan may be extended, which then permits a faster precession scan. Generally, a low laser divergence in the azimuthal direction is desired for the scanned laser beam. However, in some embodiments, a holographic diffractive pattern may be provided to a reflective surface 804 of a transmit scanner 802 to impart a divergence 806 of the laser beam 810 along a polar angle direction, as illustrated in FIG. 17. In other embodiments, an optical power may be machined into the reflective surface 804 to impart the beam divergence in the reflected laser beam 810.

At a distance, the laser beams 810 in these embodiments are elliptical as shown in FIG. 18 with the angular divergence θ_{div}. FIG. 18 additionally shows two targets, 822-1 and 822-2 being simultaneously illuminated at angle γₐ and γ_{b} relative to the elevation of the center of the laser beam 810.

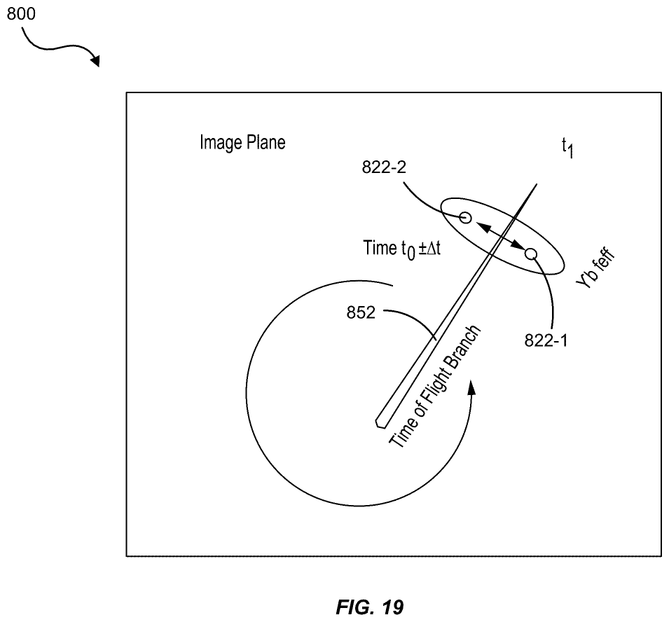

The illuminated targets 822-1 and 822-2 of FIG. 18 result in two pixel-events, both with time stamp t₁ on the event camera image plane 850 shown in FIG. 19. However, one pixel 822-1 has coordinates preceding the other pixel coordinate of pixel 822-2. The mapping of the center of the laser beam to the image plane 850 at time t₁ is known from previous calibrations, and the leading and trailing distance on the image plane 850 of the two target pixels 822-1 and 822-2 is given by γₐf_{eff} and γ_{b}f_{eff}, where f_{eff} is the focal length of the imaging system. Given the measured pixel coordinates, the target offset distances on the image plane 850 are calculated and the elevation corrections γₐ and γ_{b} are determined.

As described earlier, derotated coordinates can be calculated from the pixel event coordinates, as follows:

$${x}_{im , 0} = cos ( {θ}_{im} ) {x}_{im} + sin ( {θ}_{i m} ) {y}_{im} ,$$

$$and {y}_{i m , 0} = - sin ( {θ}_{i m} ) {x}_{i m} + cos ( {θ}_{i m} ) {y}_{i m} .$$

A previously tabulated map of target range ΔΦᵢₘ(x_{im,0}, y_{im,0}) may then be used to look up target elevation offsets. The tabulated elevation correction function includes effects of scanner fabrication errors such as clocking errors between the two monogons (e.g., the transmitter 20 and the receiver 28 of FIG. 1) and angle errors in the surface normal relative to the scanning rotation axis.

In some embodiments, the Lidar system 10 can be calibrated to reduce sensing/detection errors. Sensor calibration generally includes the development of mappings from derotated pixel coordinates to range, and potentially to elevation corrections, along with masks for acceptance or rejection of derotated pixel coordinates. Additionally, the point of image derotation in pixel coordinates within an image plane may be determined.

These mappings and masks may be determined through simulation once the point of image derotation in the camera image plane is determined and the fabrication misalignments in the dual monogon is determined. However, the masks and mappings may also be determined through more empirical means, for example, by collecting signals from fiducial targets in a field test at known angles and locations relative to the sensor and fitting a system model to the data using misalignment parameters.

As part of a demonstration shown in FIGS. 20A and 20B, an event camera by “Prophesee” was used in the Lidar system 10 to obtain a sequence of time stamped pixel coordinates with positive change and negative change event types. In FIG. 20A, the Lidar system 10 transmitted laser light 14 to detect an earthen berm 902 which is shown in the image 900. The image 900 was then filtered to remove events and pixel coordinates that could correspond to laser sweeps, over a few seconds. The extracted number of positive change events were summed over each pixel to produce the image in FIG. 20B. This post process filtering included a selection of event data based on the laser direction at the time of photon flux changes and pixel coordinates that could be illuminated from back scatter for the laser directions. Additional filtering included the rejection of event data from pixels having high event counts without laser illumination.

Any of the above embodiments herein may be rearranged and/or combined with other embodiments. Accordingly, the Lidar concepts herein are not to be limited to any particular embodiment disclosed herein. Additionally, the embodiments can take the form of entirely hardware or comprising both hardware and software elements. Portions of the embodiments may be implemented in software, which includes but is not limited to firmware, resident software, microcode, etc. FIG. 21 illustrates a computing system 1000 in which a computer readable medium 1006 may provide instructions for performing any of the methods disclosed herein.

Any of the various computing and/or control elements shown in the figures or described herein may be implemented as hardware, as a processor implementing software or firmware, or some combination of these. For example, an element may be implemented as dedicated hardware. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

In one embodiment, instructions stored on a computer readable medium direct a computing system of any of the devices and/or servers discussed herein to perform the various operations disclosed herein. In some embodiments, all or portions of these operations may be implemented in a networked computing environment, such as a cloud computing system. Cloud computing often includes on-demand availability of computer system resources, such as data storage (cloud storage) and computing power, without direct active management by a user. Cloud computing relies on the sharing of resources, and generally includes on-demand self-service, broad network access, resource pooling, rapid elasticity, and measured service.

FIG. 21 depicts one illustrative cloud computing system 1000 operable to perform the above operations by executing programmed instructions tangibly embodied on one or more computer readable storage mediums. The cloud computing system 1000 generally includes the use of a network of remote servers hosted on the internet to store, manage, and process data, rather than a local server or a personal computer (e.g., in the computing systems 1002-1-1002-N). Cloud computing enables users to use infrastructure and applications via the internet, without installing and maintaining them on-premises. In this regard, the cloud computing network 1020 may include virtualized information technology (IT) infrastructure (e.g., servers 1024-1-1024-N, the data storage module 1022, operating system software, networking, and other infrastructure) that is abstracted so that the infrastructure can be pooled and/or divided irrespective of physical hardware boundaries. In some embodiments, the cloud computing network 1020 can provide users with services in the form of building blocks that can be used to create and deploy various types of applications in the cloud on a metered basis.

Various components of the cloud computing system 1000 may be operable to implement the above operations in their entirety or contribute to the operations in part. For example, a computing system 1002-1 may be used to perform analysis of lidar data, and then store that analysis in a data storage module 1022 (e.g., a database) of a cloud computing network 1020. Various computer servers 1024-1-1024-N of the cloud computing network 1020 may be used to operate on the data and/or transfer the analysis and/or the data to another computing system 1002-N.

Some embodiments disclosed herein may utilize instructions (e.g., code/software) accessible via a computer-readable storage medium for use by various components in the cloud computing system 1000 to implement all or parts of the various operations disclosed hereinabove. Examples of such components include the computing systems 1002-1-1002-N.

Exemplary components of the computing systems 1002-1-1002-N may include at least one processor 1004, a computer readable storage medium 1014, program and data memory 1006, input/output (I/O) devices 1008, a display device interface 1012, and a network interface 1010. For the purposes of this description, the computer readable storage medium 1014 comprises any physical media that is capable of storing a program for use by the computing system 1002. For example, the computer-readable storage medium 1014 may be an electronic, magnetic, optical, electromagnetic, infrared, semiconductor device, or other non-transitory medium. Examples of the computer-readable storage medium 1014 include a solid-state memory, a magnetic tape, a removable computer diskette, a random access memory (RAM), a read-only memory (ROM), a rigid magnetic disk, and an optical disk. Some examples of optical disks include Compact Disk-Read Only Memory (CD-ROM), Compact Disk-Read/Write (CD-R/W), Digital Versatile Disc (DVD), and Blu-Ray Disc.

The processor 1004 is coupled to the program and data memory 1006 through a system bus 1016. The program and data memory 1006 include local memory employed during actual execution of the program code, bulk storage, and/or cache memories that provide temporary storage of at least some program code and/or data in order to reduce the number of times the code and/or data are retrieved from bulk storage (e.g., a hard disk drive, a solid state drive, or the like) during execution.

Input/output or I/O devices 1008 (including but not limited to keyboards, displays, touchscreens, microphones, pointing devices, etc.) may be coupled either directly or through intervening I/O controllers. Network adapter interfaces 1010 may also be integrated with the system to enable the computing system 1002 to become coupled to other computing systems or storage devices through intervening private or public networks. The network adapter interfaces 1010 may be implemented as modems, cable modems, Small Computer System Interface (SCSI) devices, Fibre Channel devices, Ethernet cards, wireless adapters, etc. Display device interface 1012 may be integrated with the system to interface to one or more display devices, such as screens for presentation of data generated by the processor 1004.

What is claimed is:

1. A Laser Ranging and Detection (Lidar) system, comprising:
a laser operable to generate laser light;
a transmitter operable to rotate at a first rate, and to transmit the laser light along a first path from the Lidar system to a target;
a receiver operable to rotate with the transmitter, and to receive at least a portion of the laser light along a second path from the target, wherein the first and second paths are different;
an event-camera having a plurality of pixels, each pixel being triggerable by photon flux changes; and
a processor operable to calculate a range and an angle to the target using an angular displacement between the second path and the receiver that arises from the first rate of rotation for the transmitter and the receiver and, in part, from event data of at least one of the pixels based on a direction of the first path at a time of a photon flux change and a pixel coordinate of the at least one pixel.

2. The Lidar system of claim 1, wherein:
the processor is further operable to select the event data by excluding pixels of the event- camera that have not been triggered from the laser light along the second path from the target.

3. The Lidar system of claim 1, wherein:
the processor is further operable to calculate the range and the angle to the target by derotating pixel event coordinates of a laser scan angle at a time of the event data, and by comparing the derotated pixel coordinates to a previously calculated pixel range map.

4. The Lidar system of claim 1, wherein:
the processor is further operable to calculate the range and the angle to the target by derotating pixel event coordinates of a laser scan angle at a time of the event data, and by comparing the derotated pixel coordinates to a previously calculated pixel elevation correction map.

5. The Lidar system of claim 1, wherein:
the receiver and the transmitter both rotate about axes aligned in a same direction.

6. The Lidar system of claim 1, wherein:
the receiver and the transmitter are attached by a common rotating shaft.

7. The Lidar system of claim 1, wherein:
the receiver and the transmitter each comprise a monogon shaped mirror.

8. The Lidar system of claim 7, wherein:
the mirrors of the receiver and the transmitter are configured at angles that are complementary to one another.

9. The Lidar system of claim 1, wherein:
at least one of the receiver and the transmitter comprises a transmissive scanner driven by a perimeter driven motor.

10. The Lidar system of claim 9, wherein:
the transmissive scanner comprises a rotating diffractive scanner.

11. The Lidar system of claim 9, wherein:
the transmissive scanner comprises a rotating refractive scanner.

12. The Lidar system of claim 1, wherein:
the receiver and the transmitter are operable to conically scan.

13. The Lidar system of claim 1, further comprising:
an axle configured to rotate the receiver and the transmitter to conically scan via a precession rotational axis.

14. The Lidar system of claim 1, wherein:
the transmitted laser light is tuned on and off of an absorption line of a volumetric target.

15. The Lidar system of claim 1, further comprising:
a detector configured to detect a wavelength of received laser light that differs from a wavelength of the transmitted laser light due to distributed scatterers.

16. The Lidar system of claim 1, wherein:
the laser light comprises continuous wave laser light.

17. A Laser Ranging and Detection (Lidar) method, comprising:
transmitting laser light from a transmitter rotating at a first rate along a first path to a target;
receiving at least a portion of the laser light along a second path from the target with a receiver rotating with the transmitter, wherein the first and second paths are different;
triggering at least one pixel, of an event-camera having a plurality of pixels, with a photon flux change; and
calculating a range and an angle to the target using an angular displacement between the second path and the receiver that arises from the first rate of rotation for the transmitter and the receiver and, in part, from event data of at least one of the pixels based on a direction of the first path at a time of a photon flux change and a pixel coordinate of the at least one pixel.
